(19) United States
(12) Patent Application Publication
(10) Pub. No.: US 2016/0253538 A1
(43) Pub. Date: Sep. 1, 2016

(54) Methods and Apparatus of Integrating Fingerprint Imagers with Touch Panels and Displays

(71) Applicants: Yang Lu, Pearland, TX (US); Weidong Shi, Pearland, TX (US)

(72) Inventors: Yang Lu, Pearland, TX (US); Weidong Shi, Pearland, TX (US)

(21) Appl. No.: 14/634,826

(22) Filed: Feb. 28, 2015

(51) Int. Cl. G06K 9/00; G06F 21/32; G06F 3/041

(52) U.S. Cl. CPC G06K 9/0002; G06K 9/00087; G06F 3/0412; G06F 3/0416; G06F 21/32

(57) ABSTRACT

The present invention provides systems and methods of an apparatus that comprises a layer of fingerprint imagers, an addressing circuit, a fingerprint controller, an electronic storage devices, a layer of touch panel and a display panel. The touch panel behind the layer of fingerprint imagers can sense touch position when touched. The specific fingerprint imagers can be activated according to the touch panel coordinates when touched by a user. After fingerprint is captured, the system evaluates quality of the captured fingerprint and admits fingerprint for recognition when its quality is above a threshold value. User of a computing system can be accepted or rejected based on the comparison between the captured fingerprint and an authorized fingerprint list.

### BACKGROUND OF THE INVENTION

### Field of the Invention

This invention relates to integrating fingerprint imagers with touch panels for supporting both access control and human computer interactions.

### BRIEF DESCRIPTION OF THE DRAWINGS

The invention may be better understood, and further advantages and uses thereof more readily apparent, when considered in view of the following detailed description of exemplary embodiments and examples, taken with the accompanying diagrams, in which:

FIG. 1 is a block diagram showing, in one exemplary embodiment of the present invention, the components involved for implementing a touch-fingerprint apparatus;

FIG. 2 is a flowchart showing, in one exemplary embodiment of the present invention, the process involved for user verification with the touch-fingerprint apparatus;

FIG. 3 is a flowchart showing, in one exemplary embodiment of the present invention, the process involved for continued user verification with the touch-fingerprint apparatus after a computing system is in accessible state;

FIG. 4 is a block diagram showing, in one exemplary embodiment of the present invention, placement of fingerprint imager and dynamic human interaction artifact; and

FIG. 5 is a block diagram showing, in one exemplary embodiment of the present invention, placement of fingerprint imager and static human interaction artifact.

While the patent invention shall now be described with reference to the embodiments shown in the drawings, it should be understood that the intention is not to limit the invention only to the particular embodiments shown but rather to cover alterations, modifications and equivalent arrangements possible within the scope of appended claims. Throughout this discussion that follows, it should be understood that the terms are used in the functional sense and not exclusively with reference to specific embodiment, implementation, programming interface.

### DETAILED DESCRIPTION OF THE PREFERRED EMBODIMENTS

Discussion in this section is intended to provide a brief description of some exemplary embodiments of the present invention.

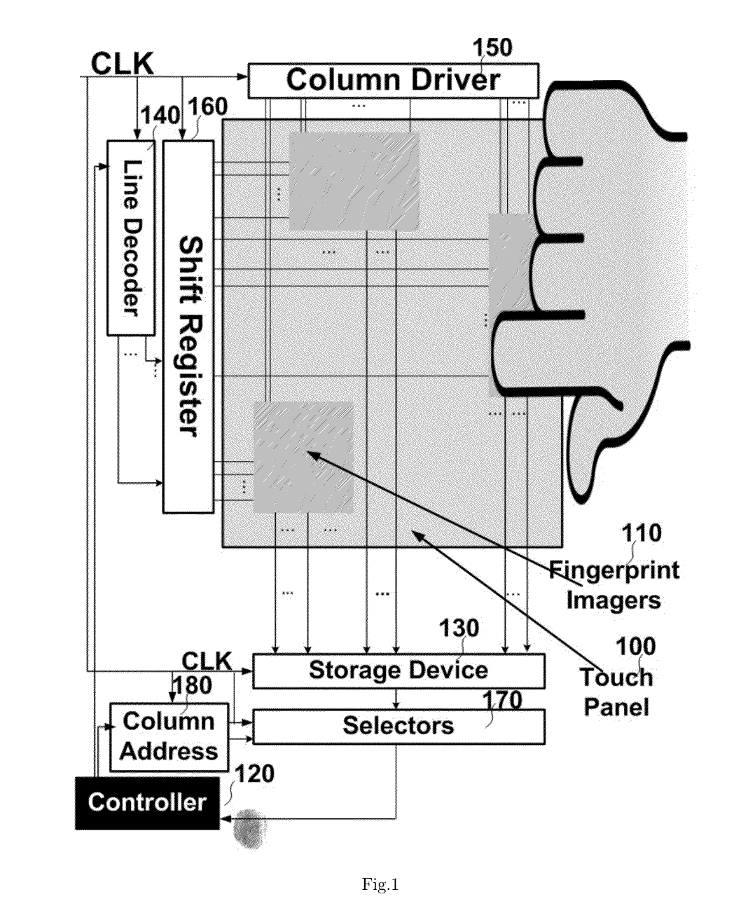

FIG. 1 is a block diagram showing, in one exemplary embodiment of the present invention, the components involved for implementing a touch-fingerprint apparatus.

A touch-fingerprint apparatus can comprise multiple fingerprint imagers (110) that are overlayed on top of a touch panel (100). A fingerprint imager is an electronic device used to capture a digital image of the fingerprint pattern. The captured image can be digitally processed to create a biometric template (a collection of extracted features) which is stored and used for matching. Fingerprint imagers include but not limited to optical fingerprint imagers, ultrasonic fingerprint imagers, thermal fingerprint imagers, capacitance fingerprint imagers, passive capacitance fingerprint imagers, and active capacitance fingerprint imagers. An touch panel can detect the presence and location of a touch (e.g., capacitive touch panel, resistive touch panel, acoustic wave touch panel, infrared touch panel, projective capacitive touch panel). A computing system (e.g., laptop, desktop, tablet, notebook, PDA, mobile phone, game console, Kiosk) can comprise at least one such touch-fingerprint apparatus and use the touch-fingerprint apparatus for access control and/or user authentication. Furthermore, in additional embodiment, a computing system can comprise one or multiple transceivers (e.g. wired transceivers, wireless transceivers).

Furthermore, in an embodiment, a fingerprint imager can be TFT (thin-film transistors) based fingerprint imager. Each TFT fingerprint imager contains a matrix of fingerprint sensing cells, basic sensing unit of a fingerprint imager. A sensing cell can comprises a upper electrode of the capacitor, a metal plate as lower electrode. The TFT fingerprint imagers (110) can be transparent by using transparent materials and transparent TFT fabrication process.

In an additional embodiment, the touch panel can be integrated with an electronic display panel (e.g., OLED displays, liquid crystal display devices such as TFT-LCD, electronic paper display). Or in alternative embodiment, an electronic display panel can be placed beneath the touch panel.

The TFT fingerprint imagers (110) are controlled by a controller (120). The controller (120) can select and activate a fingerprint imager according to predetermined conditions. In one embodiment, when finger tip is inside the region covered by a fingerprint imager, its location can be recorded. Then the controller can select and activate one or multiple fingerprint imagers to capture one or multiple fingerprints according to their locations.

The fingerprint imagers and fingerprint sensing cells can have their unique column addresses and line addresses. The controller (120) can translate a touch panel location (position in touch panel X-axis and Y-axis) into a pair of fingerprint imager line address and column address. The line address decoder(140) can decode a line address and send the decoding output to a shift register (e.g., parallel-in parallel-out shift register). The shift register (160) can enable one row of fingerprint sensing cells at a time. In one embodiment, the fingerprint sensing cells in the enabled row can be addressed during a clock cycle and disabled after results of the sensing cells are converted into digital values and fed into the storage devices (physical storage used to temporarily hold data such as latches, flip-flops, or buffers) that are situated at the end of each column (130). Sensed results stored in the storage devices are selected and transmitted to the controller (120). In one embodiment, the controller can compute a pair of column addresses(180) as beginning and end column addresses. Results stored in the storage devices (130) within the selected columns via selector(170) are transferred to the controller.

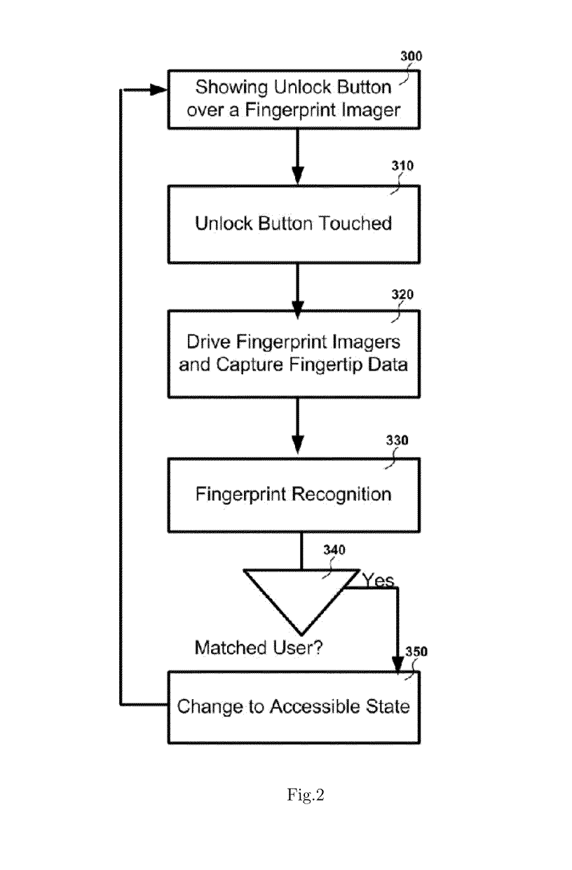

FIG. 2 is a flowchart showing, in one exemplary embodiment of the present invention, the process involved for user verification with the described touch-fingerprint apparatus in FIG. 1.

In accordance with the present invention, in one embodiment, a computing system can use a sequence of steps to authenticate a user with the touch-fingerprint apparatus. Furthermore, in additional embodiment, a computing system (e.g., laptop, desktop, tablet, notebook, PDA, mobile phone, game console, Kiosk) can be locked. The computing system can be unlocked using the steps in FIG. 2.

In an embodiment, when a computing system is locked, an unlock button (e.g., dynamic or static button) can be shown over one or multiple fingerprint imagers (300). A user can touch the unlock button to unlock the computing system. When the unlock button is touched (310), the controller can activate one or multiple fingerprint imagers and capture one or multiple fingerprint images (320). The captured fingerprint can be matched against fingerprints of a list of authorized users (330). If the fingerprint is accepted as one of the authorized users', the computing system is unlocked and it is in accessible state (350). When the computing system is in accessible state, a state that the system is unlocked, permissions granted to the user are to access certain part, or all functions of the system, including login to user accounts, using Internet, modifying settings, file access. Or when a computer system is in accessible state, it can be controlled or respond to interactive user inputs.

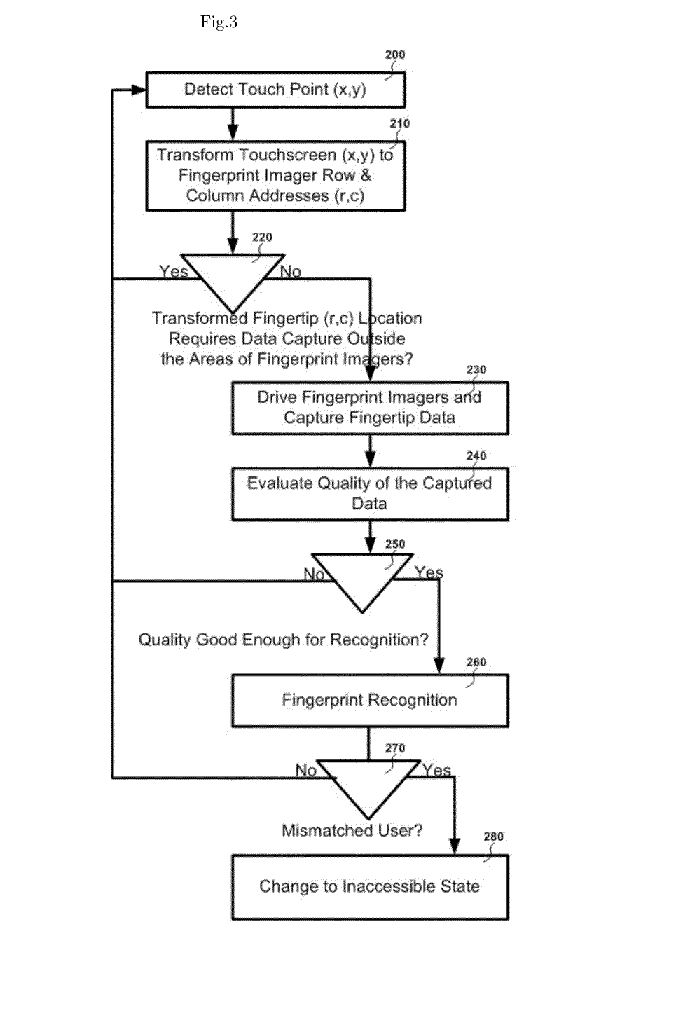

FIG. 3 is a flowchart showing, in one exemplary embodiment of the present invention, the process involved for continued user verification with the described touch-fingerprint apparatus in FIG. 1 after a computing system is in accessible state.

In accordance with the present invention, in one embodiment, after a computer system is unlocked or is in accessible state, the computing system that comprises the touch-fingerprint apparatus can keep verifying the user using fingerprint when the user interacts with the computing system. In one embodiment, user verification can be performed when the user touches the touch-fingerprint apparatus and fingerprint can be captured.

An embodiment can choose when and how often fingerprint based user verification is performed. For example, in one embodiment, user verification can be tried for every touch when fingerprint can be captured. In another embodiment, user verification is performed periodically or randomly in time. In additional embodiment, one or multiple conditions can be defined as triggers for fingerprint based user verification. When the conditions are met, user verification can be performed. For instance, in one embodiment, a condition can be defined as, when certain region of the touch panel is touched by the user, user verification will be started. The computing system may use the region for displaying one or multiple human interaction artifacts (e.g., icon, button, menu). When the region is touched, fingerprint can be captured by the touch-fingerprint apparatus and be verified using fingerprint recognition.

In an embodiment, when a user touches the touch panel (200), a touch event can be generated and touch location (e.g., touch panel coordinate) is recorded. When the controller (120) gets the touch event and its touch panel coordinate, it can calculate the corresponding fingerprint imager coordinate according to each fingerprint imager's location mapped to the touch panel space (210). If the calculated fingerprint imager coordinate is within the data capture range of one or multiple fingerprint imagers, the controller can enable these specific fingerprint imagers and capture the fingerprint by selecting the rows and columns surrounding the touch point (230).

In an embodiment, for captured fingerprint, before it is admitted for fingerprint recognition, its quality can be evaluated (240). Variety of reasons may lead to poor fingerprint quality (e.g. move too fast, press too soft, incomplete data). Low quality fingerprint data can be discarded before admitted. Fingerprint recognition can be applied to the admitted fingerprint (260). If the admitted fingerprint does not match, the computing system can take pre-determined actions as response (280). These comprise putting the system in in-accessible state (e.g., A state that the system is locked). In an embodiment, when the system is in in-accessible state, permission to access certain, part, or all functions of the system is denied. Those functions include but not limited to, access to user account, Internet browsing, modifying setting, file access, launching software. Furthermore, when in in-accessible state, the response includes but not limited to, halting interactions with the user, refusing user's input, freeze the computing system, and/or logging out the user automatically.

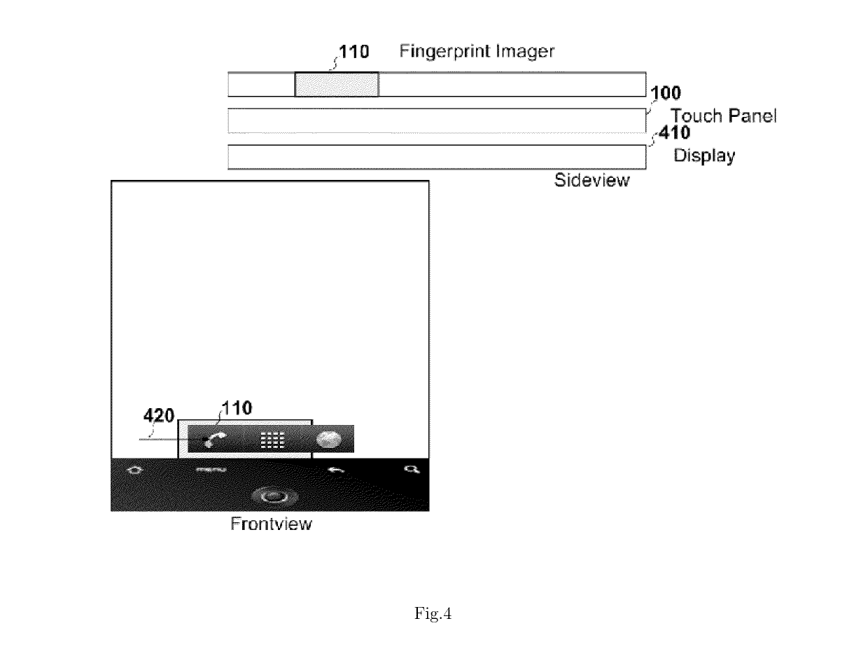

FIG. 4 is a block diagram showing, in one exemplary embodiment of the present invention, placement of dynamic user interaction artifact over fingerprint imager for user authentication.

In accordance with the present invention, in one embodiment, the electronic display (410) is behind a layer of fingerprint imagers (110). The display includes but not limited LCD display, OLED display, electronic paper display, etc. Furthermore, in additional embodiment, the display can be integrated with touch panel using add-on touch panel, in-screen touch panel, or in-cell touch enabled display.

In one embodiment, one or multiple human interaction artifacts (410) can be shown on the display (410) and overlap with the area covered by one or multiple fingerprint imagers (110). A dynamic human interaction artifact shown on a display is a graphical human interaction component that can respond to user actions, including button, icon, menu or similar human interaction component.

In an embodiment, a human interaction artifact can be commonly used GUI (Graphic User Interface) component (e.g., button, icon, menu). A human interaction artifact can be a static or dynamic component. In an embodiment, when a human interaction artifact is pressed or selected, certain functional response can be triggered. For example, in an embodiment, a human interaction artifact can include, home button, return button, cancel button, phone calling button, confirm button, menu button, search button, launch button, fire button, browser or any Internet related button.

Moreover, a human interaction artifact can be an icon used by a user to access any functional part of a computing system, including but not limited to software, configuration, setting, or files.

For example, in an embodiment shown, in FIG. 4, when a user presses the button trying to pickup a phone call, the user can be authenticated by using the touch-fingerprint apparatus.

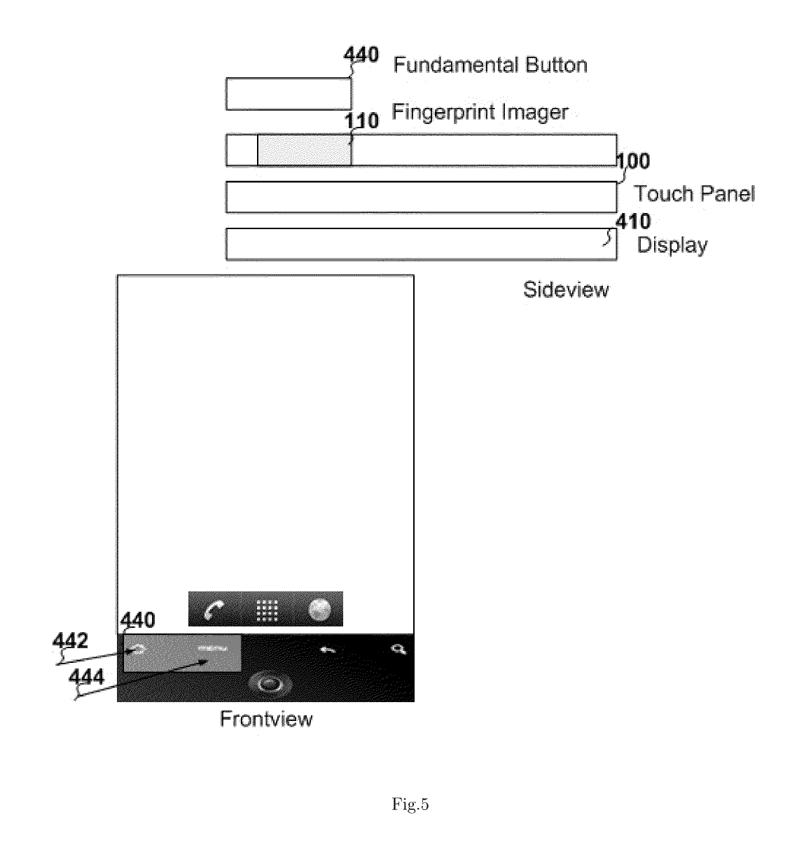

FIG. 5 is a block diagram showing, in one exemplary embodiment of the present invention, placement of static human interaction artifact over fingerprint imager for user authentication.

In accordance with the present invention, in one embodiment, a layer of static human interaction artifact (440) is in front of a layer of fingerprint imagers (110). In an embodiment, a static human interaction artifact comprises a static button, or a static icon, etc.

It should be understood that there exists implementations of other variations and modifications of the invention and its various aspects, as may be readily apparent to those of ordinary skill in the art, and that the invention is not limited by the specific embodiments described herein.

What is claimed is:

1. A touch-fingerprint apparatus comprises,
at least one layer of one or a plurality of fingerprint imagers;
at least one addressing circuit coupled with said fingerprint imagers wherein said addressing circuit can drive the fingerprint imagers using line and column addresses;
at least one set of electronic storage devices coupled with said fingerprint imagers wherein said electronic storage devices receive and store sensed fingerprint outputs from the fingerprint imagers;
at least one fingerprint controller coupled with the addressing circuit and the electronic storage devices; and
at least one touch panel behind the layer of fingerprint imagers.

2. The touch panel in claim 1 further comprising at least one display panel.

3. The touch panel in claim 2 further comprising at least one human interaction artifact shown on the displayed panel wherein said human interaction artifact is behind one of the fingerprint imagers.

4. The fingerprint imager in claim 1 further comprising a matrix of fingerprint sensing cells.

5. The fingerprint sensing cell in claim 4 is a capacitive fingerprint sensing cell.

6. The fingerprint sensing cell in claim 4 is an optical fingerprint sensing cell.

7. The addressing circuit in claim 1 further comprising,
at least one line decoder;
at least one shift register; and
at least one column driver.

8. The fingerprint controller in claim 1 further comprising at least one location translator that translates a touch panel coordinate to line and column address of the fingerprint imagers.

9. The apparatus in claim 1 further comprising at least one layer of one or a plurality of static human interaction artifacts wherein said layer is in front of the layer of fingerprint imagers.

10. The electronic storage device in claim 1 further comprising at least one latch or flip-flop.

11. A method of user verification by a computing system using a touch-fingerprint apparatus wherein said touch-fingerprint apparatus comprises, at least one layer of one or a plurality of fingerprint imagers and at least one touch panel behind the layer of fingerprint imagers wherein said touch panel when touched by a human finger can sense its touch position, said method comprises,
determining touch panel coordinate by the touch panel;
translating the touch panel coordinate into line and column fingerprint imager addresses;
activating at least one fingerprint imager according to the line and column addresses;
capturing fingerprint by the activated fingerprint imager; and
matching the captured fingerprint with fingerprints of a list of authorized fingerprints where said list comprises at least one fingerprint.

12. The method in claim 11 further comprising, when the capture fingerprint doesn't match with the authorized fingerprint list, putting the computing system in inaccessible state.

13. The method in claim 11 further comprising, when the capture fingerprint matches with the authorized fingerprint list, putting the computing system in accessible state.

14. The method in claim 11 further comprising, after a fingerprint is captured, evaluating quality of the captured fingerprint and admitting fingerprint when its quality is above one or plurality of threshold values.

15. The method in claim 11 further comprising, activating a fingerprint imager when sensed touch panel coordinate is within the fingerprint imager's sensing area.

16. A method of showing human interaction artifacts for user verification by a computing system using a touch-fingerprint apparatus wherein said touch-fingerprint apparatus comprises, at least one layer of one or a plurality of fingerprint imagers and at least one touch panel behind the layer of fingerprint imagers wherein said touch panel when touched by a human finger can sense its touch position, said method comprises,
displaying at least one human interaction artifacts behind at least one fingerprint imager;
capturing fingerprint by the fingerprint imager when the fingerprint imager is touched; and
matching the captured fingerprint with fingerprints of a list of authorized fingerprints where said list comprises at least one fingerprint.

17. The method in claim 16 further comprising, when the capture fingerprint doesn't match with the authorized fingerprint list, putting the computing system in inaccessible state.

18. The method in claim 16 further comprising, when the capture fingerprint matches with the authorized fingerprint list, putting the computing system in accessible state.

19. The method in claim 16 further comprising, encrypting captured fingerprint and transmitting the encrypted outputs over a transceiver of the computing system.

20. The human interaction artifact in claim 16 is a button or an icon.
